(19) United States
(12) Patent Application Publication
(10) Pub. No.: US 2019/0244273 A1
(43) Pub. Date: Aug. 8, 2019

(54) E-COMMERCE SYSTEM WITH A PLUGIN PLATFORM AND METHOD OF USE

(71) Applicant: Giorgi Khazaradze, Arlington, TX (US)

(72) Inventor: Giorgi Khazaradze, Arlington, TX (US)

(21) Appl. No.: 16/270,456

(22) Filed: Feb. 7, 2019

Related U.S. Application Data
(60) Provisional application No. 62/627,599, filed on Feb. 7, 2018.

(51) Int. Cl. G06Q 30/06

(52) U.S. Cl. CPC G06Q 30/0629; G06Q 30/0619; G06Q 30/0641

(57) ABSTRACT

An e-commerce system includes a processor to implement data analysis and provide an e-commerce platform through an interface to a user, the e-commerce platform being connected to a first e-commerce store; a plugin platform to be downloaded into the e-commerce platform and executed via the processor, the plugin platform providing a series of steps having identifying one or more goods selected within the first e-commerce store; generating an upsell page based on the identifying of one or more goods selected, the upsell page having one or more purchasing options to be presented to a buyer; receiving a selection from the buyer relating to the one or more purchasing options; and facilitating a checkout of the selection from the buyer, the plugin platform receives at least an identifying information and a payment information.

### BACKGROUND

### 1. Field of the Invention

The present invention relates generally to e-commerce systems, and more specifically, to a plugin platform for e-commerce systems for providing upsell and cross sell pages to purchasers on an e-commerce store.

### 2. Description of Related Art

E-commerce systems are well known in the art and are effective means for users to make purchases online through online stores. For example, FIG. 1 depicts a conventional e-commerce system 101 having a user 103 shopping in an e-commerce store 104 through the internet 105, the e-commerce store 104 being implemented through a processing system including one or more of a computer 107, a database 109, and a server 111. In FIG. 2, a flowchart 201 depicts a method of use of system 101. During use, the user accesses an e-commerce store and browses through a plurality of items, as shown with boxes 203, 205. The user places one or more items in their online cart and proceeds to check out, as shown with boxes 207, 209.

One of the inefficiencies commonly associated with system 101 is lack of sale inducement for shoppers. For example, conventionally, the entire item selection process is in the hands of the purchaser, who does not receive suggestions from the e-commerce store.

Accordingly, although great strides have been made in the area of e-commerce systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a common e-commerce system;

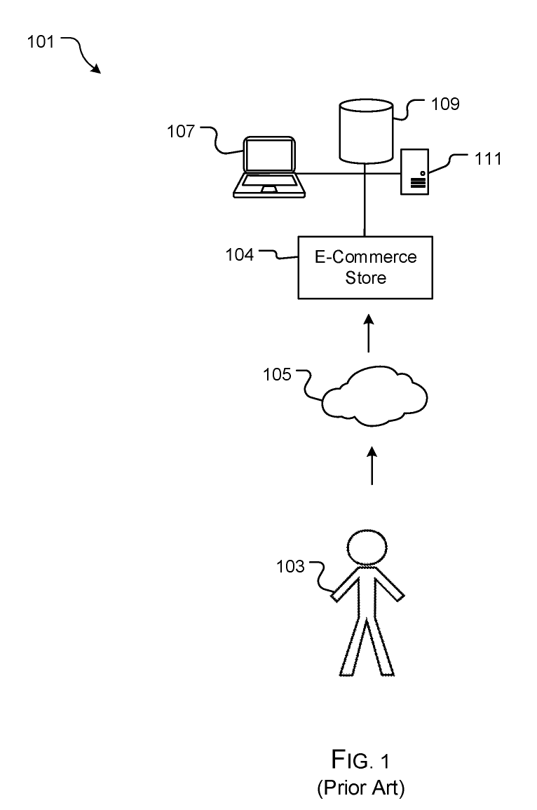

FIG. 2 is a flowchart of the method of use of the system of FIG. 1;

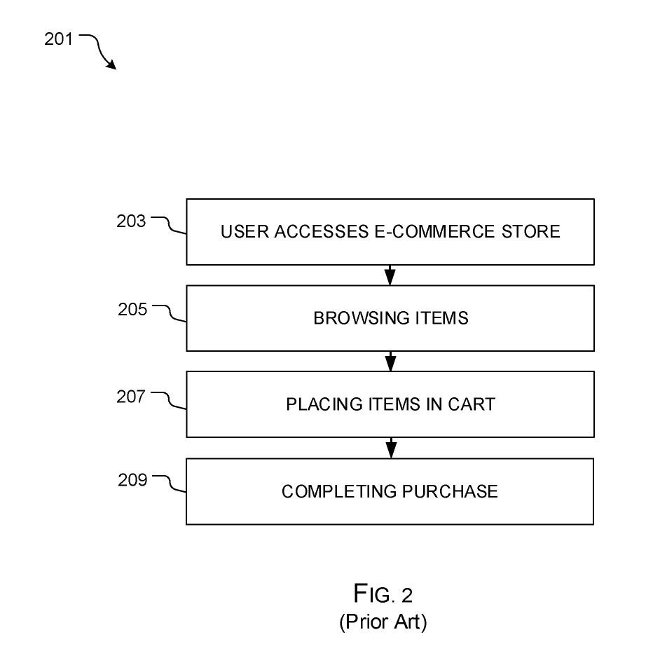

FIG. 3 is a simplified schematic of an e-commerce system with a plugin platform in accordance with a preferred embodiment of the present application;

FIG. 4 is a simplified schematic of an alternative embodiment of an e-commerce system with a plugin platform in accordance with the present application;

FIG. 5 is a simplified schematic of the plugin platform of FIGS. 3 and 4; and

FIG. 6 is a flowchart of the method of use of FIGS. 4 and 5.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional e-commerce systems. Specifically, the present invention provides a convenient means to generating inducement to purchasers on an e-commerce store through the use of upselling and cross selling techniques. In addition, the present invention provides a means to generate revenue for multiple parties. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

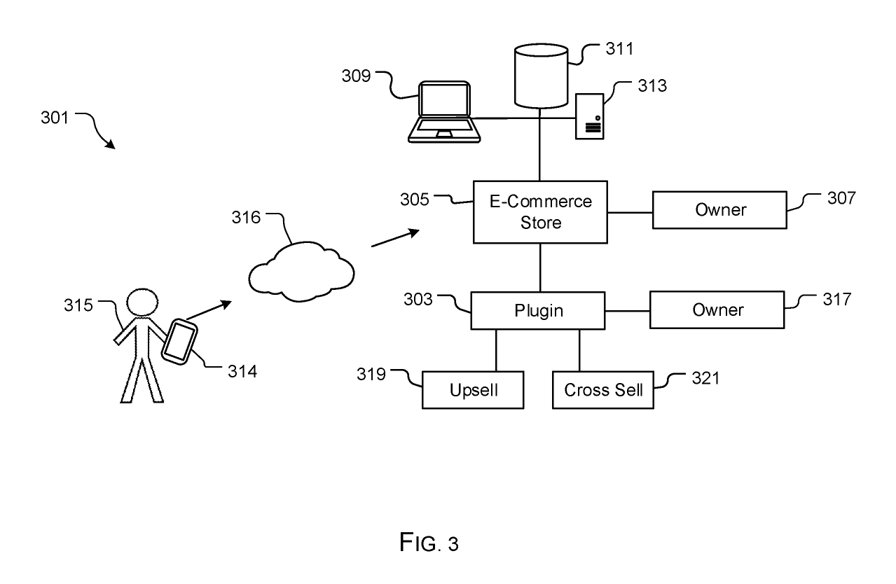

Referring now to the drawings wherein like reference characters identify corresponding or similar elements throughout the several views, FIG. 3 depicts a simplified schematic of an e-commerce system 301 with a plugin platform 303 in accordance with a preferred embodiment of the present application. It will be appreciated that system 301 overcomes one or more of the above-listed problems commonly associated with conventional e-commerce systems.

In the contemplated embodiment, system 301 includes a first e-commerce store 305 having an ownership 307 and implemented through one or more processing systems, having one or more of a computing device 309, a database 311, and a server 313. It should be appreciated that e-commerce store 305 can be any online store or collection of online stores, wherein products or services are offered for sale to a purchaser 315 through the internet 316 and a computing device 314.

In the preferred embodiment, a plugin platform 303 is integrated into the e-commerce store 305 and is associated with an ownership 317 in charge of providing the platform and collecting revenue from said platform, along with controlling the means and method in which the platform is used and is available.

Plugin platform 303 is configured to work with e-commerce store 305 to generate one or more upsell pages 319 and cross-sell pages 321, thereby providing inducement to purchaser 315 to upgrade a purchase and/or add on additional items for their purchase. It should be understood that the upsell page 319 can be associated with the e-commerce store or with the ownership of plugin platform 303. In this embodiment, after the purchaser places one or more items in their cart, the plugin platform processes information to generate suggested items from a database of items, the suggested items being based on the items already in the cart. These suggested purchases are presented to the purchaser to attempt to induce additional purchases. In this embodiment, both the e-commerce store ownership 307 and the plugin platform ownership 317 receive revenue benefit from selling additional items.

It should be appreciated that one of the unique features believed characteristic of the present application is the plugin platform 303 being configured to automatically and conveniently generate upsell and/or a cross sell pages to be presented to the purchaser. It should be appreciated that this platform provides a means for the e-commerce store and the plugin owner store to generate revenue.

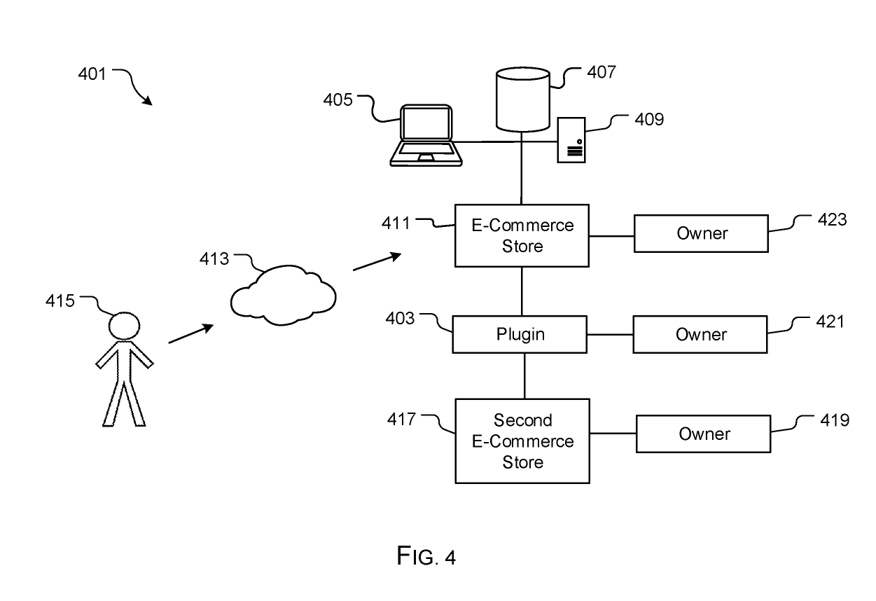

In FIG. 4, a simplified schematic depicts an e-commerce system 401 with a plugin platform 403 in accordance with the present invention. Platform 403 is similar in form and function to platform 303 and the features discussed herein should be considered to be implemented throughout both platforms. A processing system having one or more of a computer 405, database 407, and server 409 are used to provide access to a first e-commerce store 411 through internet 413 by a purchaser 415. In addition, the processing system is configured to implement information processing as it relates to the various components discussed herein. In this embodiment, plugin platform 403 is in communication with a second e-commerce store 417 with ownership 419, the second e-commerce store 417 being a third party desiring to advertise through e-commerce store 411. In this embodiment, a cross sell page can be created with one or more of the second-ecommerce store's products, thereby inducing the purchaser to make a purchase of one or more of said items. This system can therefore generate upsell pages and cross selling pages based on goods for one or more of the first e-commerce store, the plugin platform ownership 421, and the second e-commerce store, thereby generating a means for each of the ownerships 423, 421, 419 to generate revenue. This provides a mutually beneficial system for all parties.

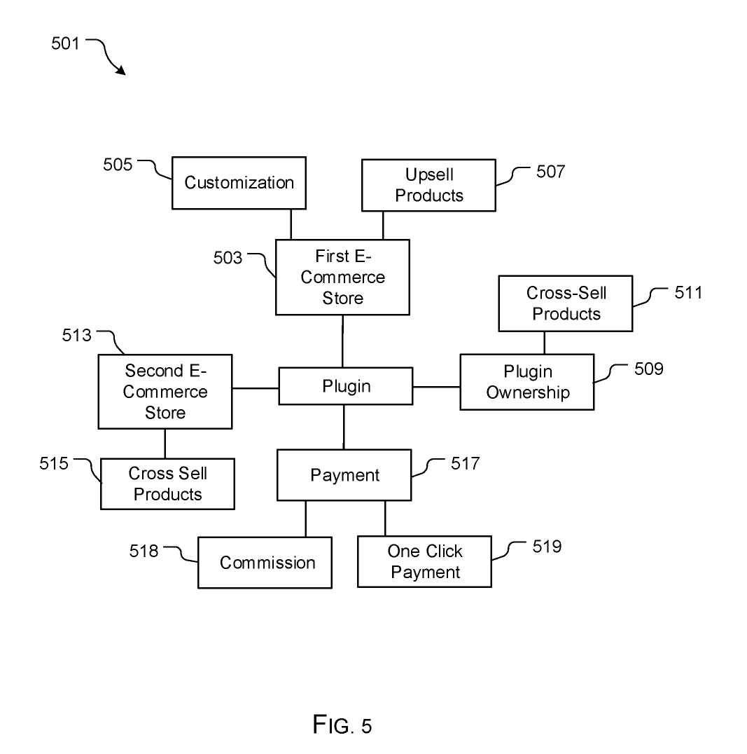

In FIG. 5, a simplified schematic of a plugin platform 501 is shown. It should be understood that plugin platform 501 can be incorporated into either of the systems discussed above. Plugin platform 501 includes a first e-commerce store portal 503 configured to provide a means for the first e-commerce store to customize 505 the upsell and cross selling pages to be presented to customers. In addition, portal 503 provides a means for the first store to select products or series of products 507 to be available in the upsell page, thereby inducing purchase of these items. It should be appreciated that the first store can further select third party stores for advertisement on the cross-selling pages.

Plugin platform 501 further includes the plugin ownership portal 509 wherein the owner of the plugin platform can designate items 511 to be incorporated into the cross selling pages, thereby inducing purchase. Plugin platform 501, in some embodiments, can also include a second e-commerce store portal 513 allowing for third party stores to sign up to become advertisers, wherein their products 515 can be implemented into the one or more cross selling pages of the first e-commerce store.

Lastly, plugin platform 501 can include a payment portal 517 configured to receive payments from purchasers for items purchased from the upsell and cross selling pages. The payment portal 517 can receive identifying and payment information for completion of the payment. In addition, the payment portal 517 can be linked to plugin 501 to process transferring of commission payments to the parties involved. For example, when one of the second e-commerce products are selected and sold via the cross selling page, the revenue generated will be divided among the parties involved, wherein the first e-commerce ownership receives a commission from advertising, the plugin platform ownership receives commission for building a connection between the first and second stores, and the second store ownership receives the remaining revenue generated from the sale. In some embodiments, when the second e-commerce ownership is not involved, the plugin ownership can receive commission from the first store for aiding in additional revenue, or alternatively, the plugin platform ownership can provide the plugin in return for the advertising of the plugin platform's products on the cross selling page.

Further, the payment portal 517 can be configured to provide the purchaser with a one click payment option 519, wherein the purchaser's information is stored from a prior purchase, thereby allowing for fast and efficient payment generation.

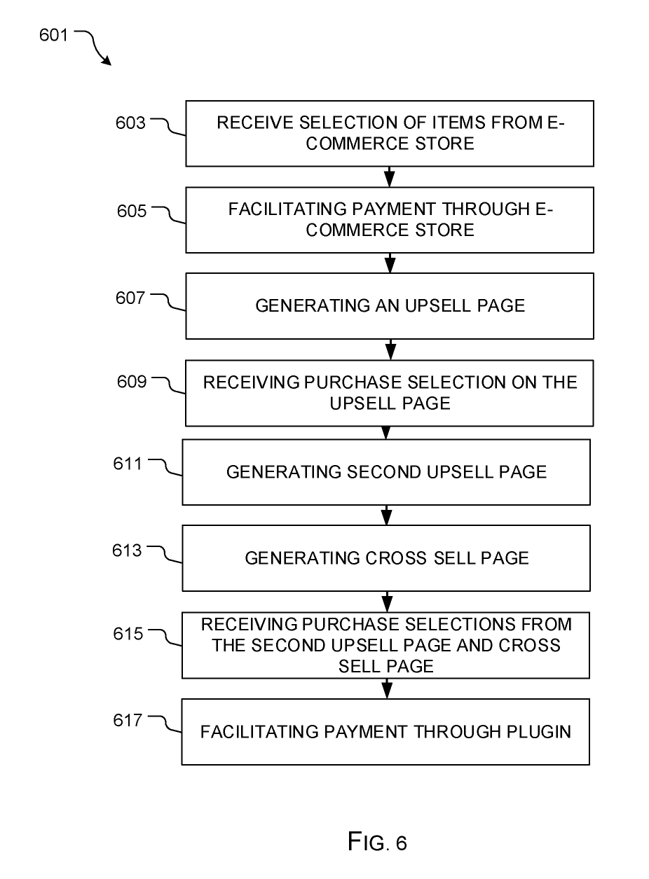

In FIG. 6, a flowchart depicts the method of systems 301 and 401. The plugin platform and processing system receives a selection of items by the purchasers, such as when the purchaser places the items in a cart, as shown with box 603. Payment for the items are facilitated through the e-commerce store payment system, as shown with box 605. Based on the items in the cart, one or more upsell pages are displayed to the purchaser, wherein the user can make a selection of additional items to purchase, as shown with boxes 607, 609, 611. A cross sell page is further generated with items from one or both of the plugin platform ownership and a third party seller, as shown with box 613. Payment for items selected on the upsell pages and/or the cross sell page is generated through the plugin platform, as shown with boxes 615, 617. The payment received is then dispersed according to the prearranged agreement between the parties in place.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An E-Commerce system, comprising:
a processor configured to implement data analysis and provide an e-commerce platform through an interface to a user, the e-commerce platform being connected to a first e-commerce store;
a plugin platform configured to be downloaded into the e-commerce platform and executed via the processor, the plugin platform providing a series of steps having:
identifying one or more goods selected within the first e-commerce store;
generating an upsell page based on the identifying of one or more goods selected, the upsell page having one or more purchasing options to be presented to a buyer;
receiving a selection from the buyer relating to the one or more purchasing options; and
facilitating a checkout of the selection from the buyer, wherein the plugin platform receives at least an identifying information and a payment information.

2. The system of claim 1, wherein the series of steps further comprises:
providing a customization portal to a management system of the e-commerce store;
wherein the management system can customize an appearance associated with the upsell page.

3. The system of claim 1, wherein the series of steps further comprises:
generating a cross-selling page based on the identifying of one or more goods selected, the cross-selling page providing one or more purchasing options relating to a second e-commerce store associated with a seller different from the first e-commerce store.

4. The system of claim 3, wherein the seller is an owner of the plugin platform.

5. The system of claim 3, wherein the seller is a third-party seller not affiliated with the plugin platform.

6. The system of claim 5, wherein the series of steps further comprises:
generating a revenue stream associated with payment received through the facilitating of the checkout;
wherein the revenue stream provides a commission to an owner of the first e-commerce store based on a selection of the one or more purchasing options relating to the second e-commerce store.

7. The system of claim 1, wherein the series of steps further comprises:
saving the identifying information and the payment information; and
providing a one-step payment option.

8. The system of claim 1, wherein the series of steps further comprises:
generating a revenue stream associated with payment received through the facilitating of the checkout;
wherein the revenue stream provides a commission to an owner of the plugin platform for the selection relating to the one or more purchasing options.

9. A method of providing increased revenue for one or more e-commerce stores, the method being implemented through computer processing of a plugin platform integrated into a first e-commerce store, the method comprising:
receiving a selection of one or more items from the e-commerce store, wherein the one or more items are placed in an online shopping cart;
facilitating payment for the one or more items through the e-commerce store payment system;
generating an upsell page via the plugin platform, the upsell page being based off of the selection of one or more items from the e-commerce store, the upsell page having one or more purchasing options;
receiving selections of the one or more purchasing options; and
facilitating payment for the one or more purchasing options through the plugin platform.

10. The method of claim 9, further comprising:
providing customization options to the first e-commerce store owner, the customization options relating to a visual appearance of the upsell page.

11. The method of claim 9, further comprising:
generating a cross-selling page based on the identifying of one or more items selected, the cross-selling page providing one or more purchasing options relating to a second e-commerce store associated with a second seller different from the first e-commerce store.

12. The method of claim 11, wherein the second seller is an owner of the plugin platform.

13. The method of claim 11, wherein the second seller is a third party seller.

14. The method of claim 13, further comprising:
generating a revenue disbursement based on the facilitating of payment for the one or more purchasing options through the plugin platform;
wherein the revenue disbursement provides a commission to an owner of the first e-commerce store.

15. The method of claim 9, further comprising:
generating a revenue disbursement based on the facilitating of payment for the one or more purchasing options through the plugin platform;
wherein the revenue disbursement provides a commission to an owner of the plugin platform.
